(19) United States
(12) Patent Application Publication
(10) Pub. No.: US 2006/0274784 A1
(43) Pub. Date: Dec. 7, 2006

(54) Methods and systems for cross-platform message exchange

(75) Inventors: Kuan-Sheng Hsueh, Tainan City (TW); Chih-Ju Tai, Taipei City (TW); I-Kuei Tseng, Zhubei City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Mediatek Incorporation

(21) Appl. No.: 11/143,693

(22) Filed: Jun. 2, 2005

(51) Int. Cl. H04L 12/54; H04J 3/16

(52) U.S. Cl. 370/466; 370/428

(57) ABSTRACT

A method for cross-platform message exchange utilized in two devices (e.g. a first device and a second device) is provided. At least one module in the first device is transmitted to the second device. The method receives a message, determines whether the message is delivered to the module, and, if so, distributes the message to the second device and transforms the message into a format compatible with the second device.

### BACKGROUND

The invention relates to methods and systems for cross-platform message exchange, and more particularly, to software testing methods and systems relating to cross-platform message exchange.

A software application program having a plurality of message-based modules is implemented in a hardware platform, such as a mobile phone device. During software developing stage, to ensure all modules in the software program would function correctly, a testing or simulating procedure is needed. However, taking a mobile phone device for example, numerous software modules are required to complete a particular task, such as a communication handshake, interface operations, information retrieval and the like. Therefore, involving numerous software modules makes tracing and monitoring computational operations during testing become extremely difficult and power consuming. To effectively test or simulate any of the modules, it is better to perform the power consuming testing procedure in another hardware platform, such as a computer.

However, while testing the functions of the modules, the computer is not able to provide an identical environment exactly like mobile phone device. For example, since the computer lacks physical components to dial a phone call, it is impossible to test the dialing function of mobile phone by performing the testing procedure on the computer.

Accordingly, lacking of real physical hardware components to support simulation, computers are not adequate environment.

### SUMMARY

Methods for cross-platform message exchange utilized in two devices (e.g. a first device and a second device) are provided. At least one module in the first device is transmitted to the second device. An embodiment of a method receives a message, determines whether the message is delivered to the module, and, if so, distributes the message to the second device and transforms the message into a format compatible with the second device.

A machine-readable storage medium storing a computer program which, when executed by a computer system, performs the method of message exchange is also provided.

Systems for cross-platform message exchange between a first device and a second device are provided. At least one module in the first device is transmitted to the second device. An embodiment of a system comprises a message distributor and a converter. The message distributor, disposed at the first device, receives a message, determines whether the message is delivered to the module, and distributes the message to the second device if the message is delivered to the module. The converter 93 transforms the message into a format compatible with the second device.

### DESCRIPTION OF THE DRAWINGS

The invention will become more fully understood by referring to the following detailed description of embodiments with reference to the accompanying drawings, wherein:

FIG. 1 is a diagram of an embodiment of a message exchange system;

FIG. 2 is a diagram of an embodiment of a mobile device;

FIG. 3 is a diagram of a hardware environment applicable to a computer;

FIG. 4 is a flowchart showing an embodiment of a method for cross-platform message exchange;

FIG. 5 is a diagram of a storage medium storing a computer program providing an embodiment of a method of message exchange;

FIG. 6 is a block diagram showing an embodiment of a system for cross-platform message exchange between a first device and a second device;

FIG. 7 is a flowchart showing an embodiment of a method for cross-platform message exchange;

FIG. 8 is a schematic diagram showing the data structure of an exemplary message database;

FIG. 9 is a block diagram showing an embodiment of a message exchange system.

### DESCRIPTION

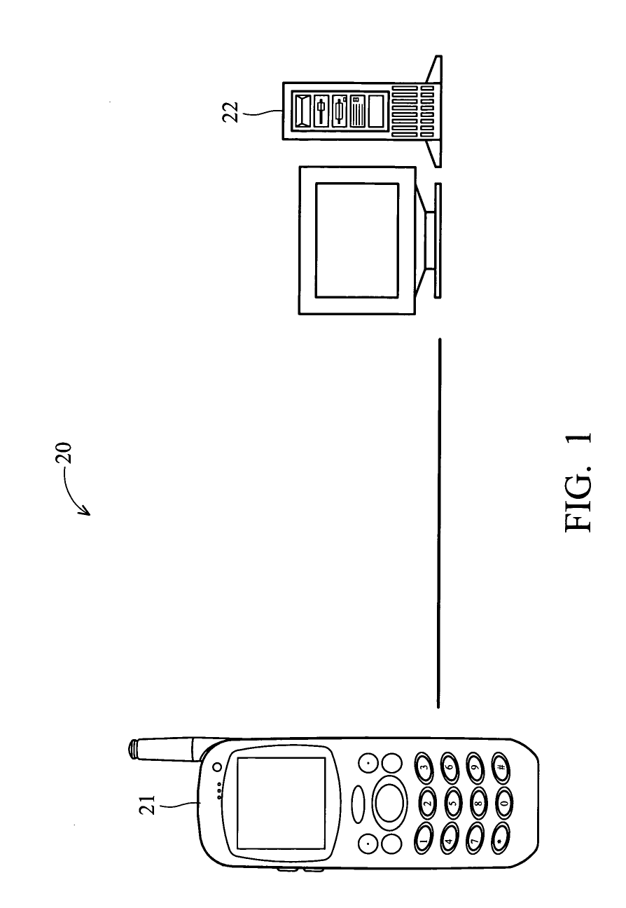

FIG. 1 is a diagram of an embodiment of a message exchange system 20, comprising a mobile device 21 and a testing computer 22 connected therebetween. The software to be tested comprises multiple software modules, a portion of modules may be hosted by an application program, such as a test program or debug program, executed in the testing computer 22, and the others are resident in the mobile device 21. The mobile device 21 and the testing computer may be connected via TCP/IP, 802.11x, RS232 or Bluetooth connection.

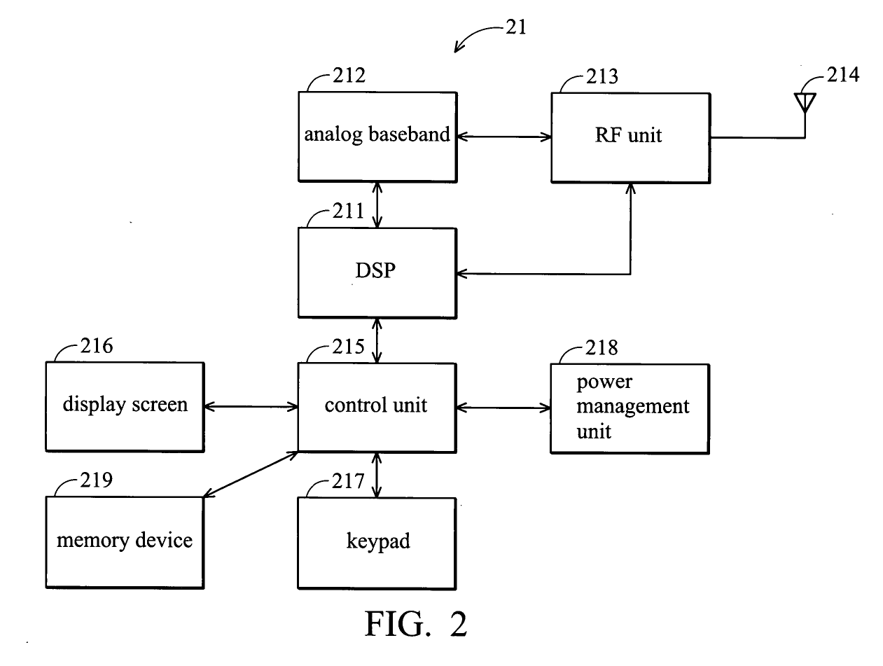

FIG. 2 is a diagram of an embodiment of a mobile device comprising a DSP (digital signal processor) 211, an analog baseband 212, a RF (Radio Frequency) section 213, an antenna 214, a control unit 215, a display screen 216, a key pad 217, a power management unit 218 and a memory device 219. Moreover, those skilled in the art will understand that some embodiments may be practiced with other embedded system devices, including PDAs (digital personal assistants), MP3 players, portable disk drives, programmable consumer electronics, and the like. The control unit 215 may be a (MPU) micro-processing unit loading and executing tested modules from the memory device 219. The memory device 219 is preferably a random access memory (RAM), but may also include read-only memory (ROM) or flash ROM, storing tested modules.

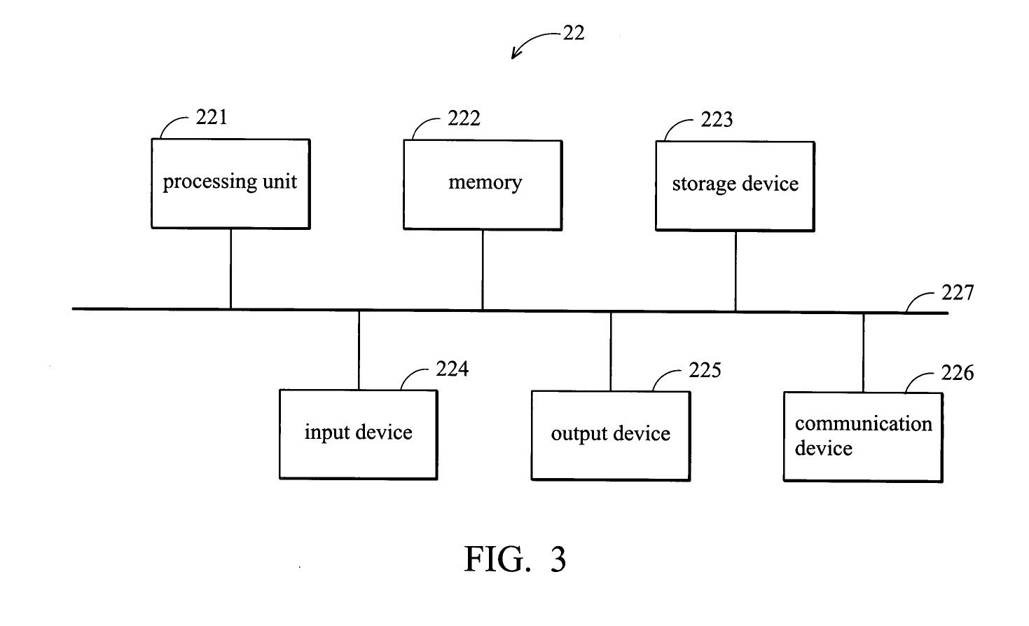

FIG. 3 is a diagram of a hardware environment applicable to computer 22 in an embodiment of a message exchange system. The hardware environment of FIG. 3 includes a processing unit 221, a memory 222, a storage device 223, an input device 224, an output device 225 and a communication device 226. The memory 222 is preferably a random access memory (RAM), but may also include read-only memory (ROM) or flash ROM. The memory 222 preferably stores program modules executed by the processing unit 221 to perform message exchange functions for heterogeneous hardware platforms. Generally, program modules include routines, programs, objects, components, scripts, Web pages, or others, that perform particular tasks or implement particular abstract data types. Moreover, those skilled in the art will understand that some embodiments may be practiced with other computer system configurations, including hand-held devices, multiprocessor-based, microprocessor-based or programmable consumer electronics, network PCs, minicomputers, mainframe computers, and the like. Some embodiments may also be practiced in distributed computing environments where tasks are performed by remote processing devices linked via a communication network. In a distributed computing environment, program modules may be located in both local and remote memory storage devices based on various remote access architecture such as DCOM, CORBA, Web objects, Web Services or other similar architectures. The storage device 223 may be a hard drive, magnetic drive, optical drive, portable drive, or nonvolatile memory drive. The drives and associated computer-readable media thereof (if required) provide nonvolatile storage of computer-readable instructions, data structures and program modules.

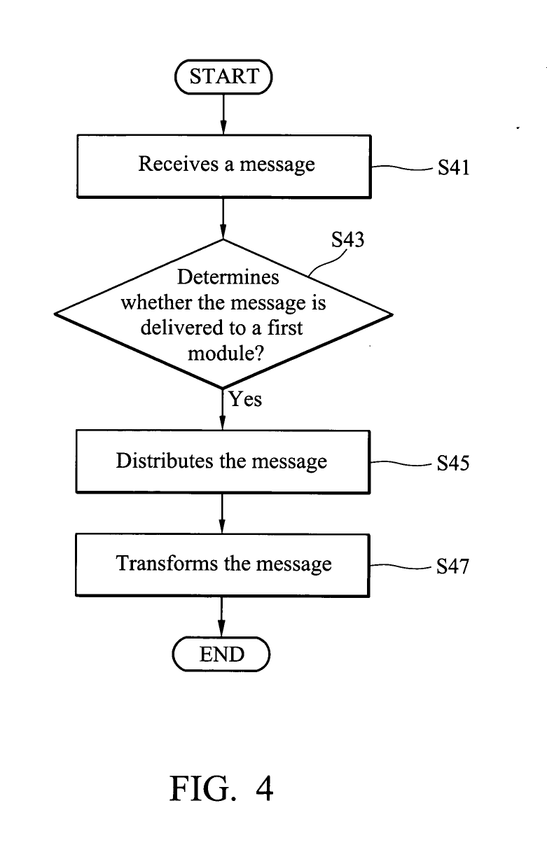

FIG. 4 is a flowchart showing an embodiment of a method for cross-platform message exchange between two devices, a first device and a second device. It is assumed that at least one message of a module in the first device is transmitted to the second device. In step S41, a message is received. In step S43, it is determined whether the message is going to be delivered to the first module, if so, the process proceeds to step S45. In another aspect, it is determined whether the message should be delivered to another module resident in the second device. In step S45, the message is distributed to the second device. In step S47, the message is transformed into a format compatible with the second device.

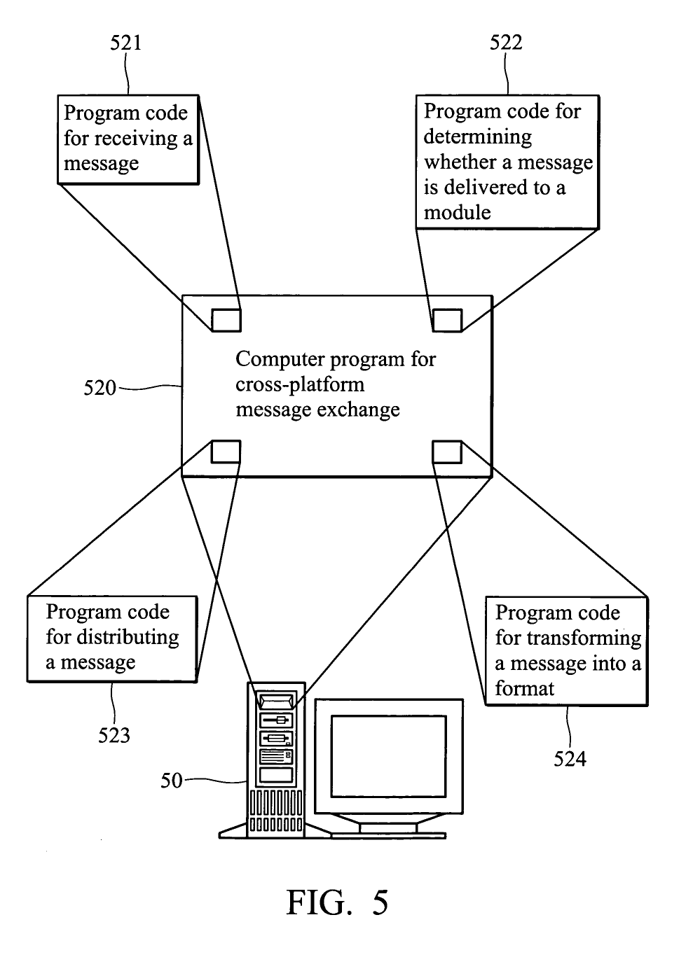

Also disclosed is a storage medium as shown in FIG. 5 storing a computer program 50 providing the disclosed embodiment of the method for message exchange. The computer program product includes a storage medium 520 having computer readable program code therein for use in a computer system, comprising at least computer readable program code 521 receiving a message, computer readable program code 522 determining whether a message is delivered to a module, computer readable program code 523 distributing a message and computer readable program code 524 transforming a message into a format.

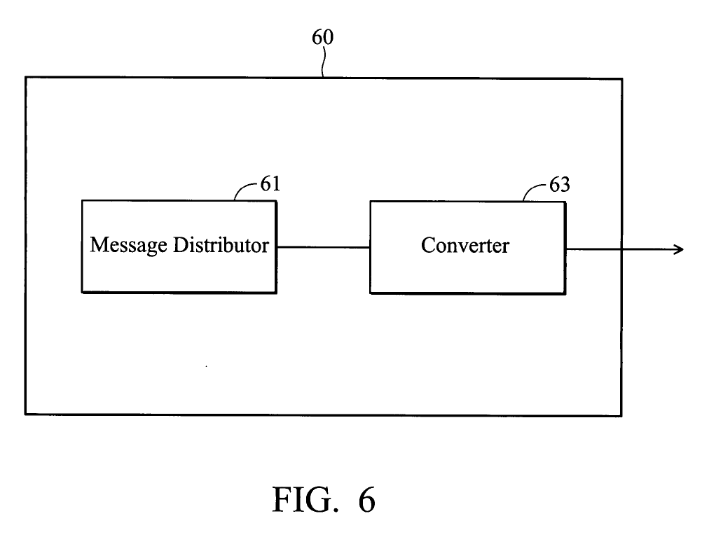

FIG. 6 is a block diagram showing an embodiment of a system for cross-platform message exchange between a first device and a second device. At least one message of a module in the first device is transmitted to the second device. The message exchange system 60 comprises a message distributor 61 and a converter 63. The message distributor 61, disposed at the first device, receives the message, and determines whether the message is going to be delivered to a module in the second device. If yes, the message distributor 61 distributes the message to the module in the second device. Meanwhile, before that, the converter 63 will transform the message into a format compatible with the second device.

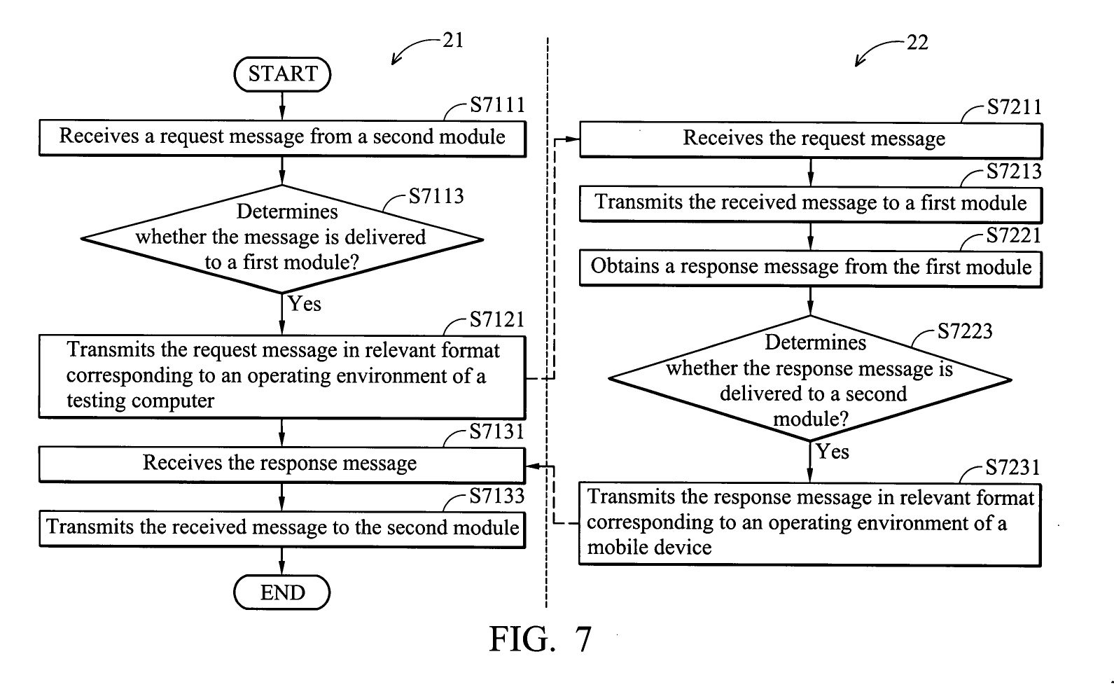

FIG. 7 is a flowchart showing an embodiment of a method for cross-platform message exchange, divided into two sections, a left section showing steps performed by the mobile device 21, and a right section showing steps performed by the testing computer 22, separated by dashed lines for added clarity. The testing computer 22 comprises a first module and the mobile device 21 comprises a second module. The first module may be associated with an application program, such as a debug program or a test program, enabling tracing and monitoring of the execution of the first module.

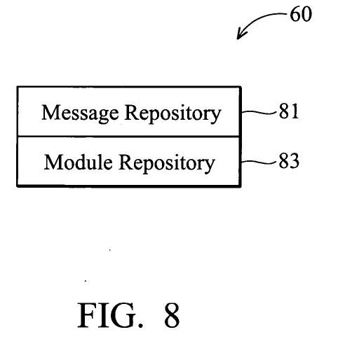

In step S7111, a request message is received from the second module. In step S7113, it is determined whether the request message is delivered to the first module, if so, the process proceeds to step S7121. In another aspect, it is determined whether the request message is delivered to a first module resident in the testing computer 22. In step S7121, the request message in relevant format corresponding to an operating environment of the testing computer 22 is transmitted to the testing computer 22. The format may be retrieved from a message database. The operating environment of the testing computer may be an emulator utilizing software to emulate mobile device hardware. FIG. 8 is a schematic diagram showing the data structure of an exemplary message database 80. The message database 80 typically contains a message repository 81 storing specifications for each message in heterogeneous operating environments, such as message name, parameters therein and parameter alignment and the like, and a module repository 83 storing specifications of each module.

In step S7211, the request message is received from the mobile device 21. In step S7213, the received message is transmitted to the first module. In step S7221, a response message corresponding to the request message is obtained from the first module. In step S7223, it is determined whether the response message is delivered to the second module, if so, the process proceeds to step S7231. In another aspect, it is determined whether the response message is delivered to a module resident in the mobile device 21. Note that execution details of the first module, such as variable values, code coverage, branch coverage and the like, may be traced and monitored via the associated application program. In step S7231, the response message in relevant format corresponding to an operating environment of the mobile device 21 is transmitted to the mobile device 21. The operating environment of the mobile device 21 may be an operating system of a mobile device. The format may be retrieved from the message database 60.

In step S7131, the response message is received from the testing computer 22. In step S7133, the received message is transmitted to the second module.

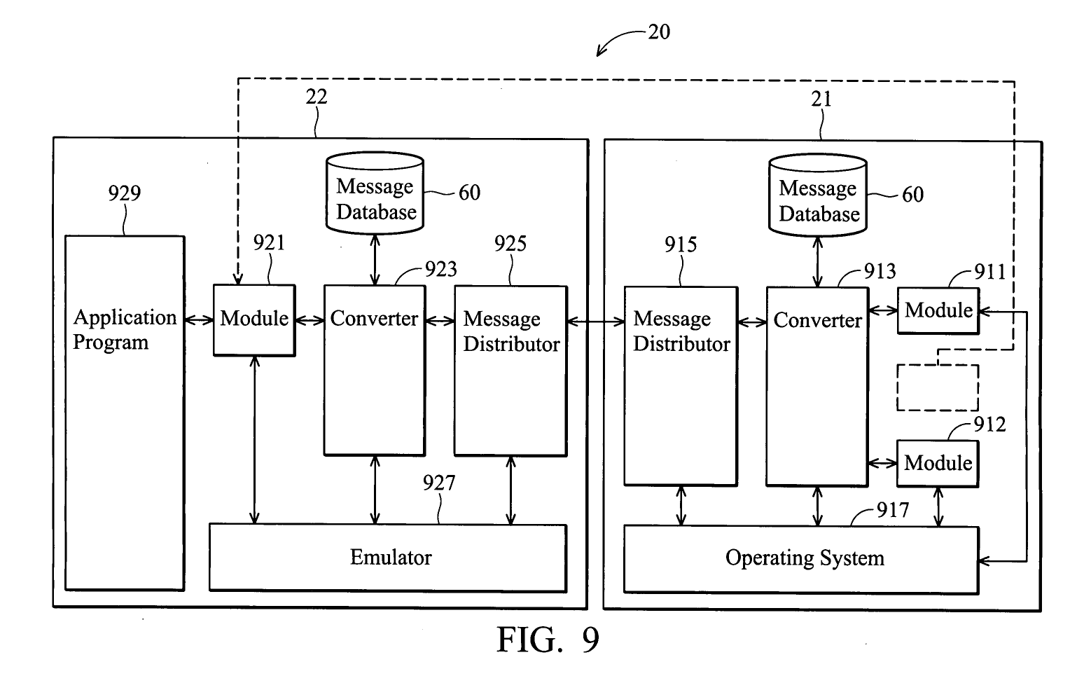

FIG. 9 is a block diagram showing an embodiment of a message exchange system 20, comprising the mobile device 21 and the testing computer 22. The testing computer 22 comprises a module 221 to be tested, and the mobile device 21 comprises modules 211 and 212. In some embodiments, the module 921 may be originally transmitted to the testing computer 22 from the mobile device 21. For example, the module 921 could be a RF module originally implemented in the mobile device 21, responsible for transmitting or receiving signals from the air. Furthermore, in the present invention, there could be more than one module 221 to be tested. On the other hand, the module 921 may be associated with an application program 929, such as a debug program or a test program, enabling tracing and monitoring of the execution of the module 921. The application program 929 may be an integrated testing environment providing various tracing and monitoring functions, such as setting breakpoints, code and branch coverage detection, step-by-step tracing or others. The mobile device 21 further comprises the message database 60, a converter 913, a message distributor 915 and an operating system 917. The testing computer 22 further comprises the message database 60, a converter 923, a message distributor 925 and an emulator 927.

The converter 913 receives a request message from the module 911 or 912, and determines whether the request-message should be delivered to the module 921. If so, the message distributor 915 transmits the request message to the testing computer 22. The message distributor 925 in the testing computer 22 will send the request message to a corresponding converter 923 and the converter 923 will transform the received request message in relevant format corresponding to an operating environment of the testing computer 22. The format may be retrieved from the message database 60 therein. The operating environment of the testing computer may be the emulator 929 utilizing software to emulate mobile device hardware. In some embodiments, the message distributor 915 transmits the transformed request message to the message distributor 925 via TCP/IP, 802.11x, RS232 or Bluetooth connection.

In some embodiments, after the message distributor 925 transmits the request message to the module 921 via the converter 923, the module 921 might generate a response message for the module 911 or 912 in the mobile device 21. While obtaining the response message from the module 921, the converter 923 determines whether the response message should be delivered to the module 911 or 912, and if so, the message distributor 925 will transmit the response message to the mobile device 21. The message distributor 915 in the mobile device 21 will receive the response message to the converter 913 and the converter 913 will transform the received response message in relevant format corresponding to an operating environment of the mobile device 21. However, it should be further noted that the converter 913 and 923 could both be used to transform the format of the messages from either the mobile device 21 or the testing computer 22. Therefore, before being transmitted to the other device, either the mobile device 21 or the testing computer 22, all messages can be transmitted into a proper format. That is, while the converter 923 determines that the response message should be delivered to the module 911 or 912, before distributing, the response message can be transformed in relevant format corresponding to an operating environment of the mobile device 21 by the converter 923. In some embodiment, it is optional to apply one or two converters in the invention. Thus, to save the cost, one of the converters 913 or 923 can be emitted. Then, the message distributor 915 will further transmit the transformed response message to the message distributor 915 via TCP/IP, 802.11x, RS232 or Bluetooth connection.

The message distributor 915 transmits the response message to the module 911 or 912 via the converter 913. Note that the converters 913 and 923 play a role of intervener to monitor all messages between modules and transform messages into relevant formats if required.

Message exchange systems and methods, or certain aspects or portions thereof, may take the form of program code (i.e., instructions) embodied in tangible media, such as floppy diskettes, CD-ROMS, hard drives, or any other machine-readable storage medium, wherein, when the program code is loaded into and executed by a machine, such as a computer, the machine becomes an apparatus for practicing the invention. The disclosed methods and systems may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing the invention. When implemented on a general-purpose processor, the program code combines with the processor to provide a unique apparatus that operates analogously to specific logic circuits.

Although the invention has been described in terms of preferred embodiment, it is not limited thereto. Those skilled in this technology can make various alterations and modifications without departing from the scope and spirit of the invention. The invention is not limited to merely test or simulation applications. Any applications relating to cross-platform message exchanging should be covered by the scope of the invention. Therefore, the scope of the invention shall be defined and protected by the following claims and their equivalents.

What is claimed is:

1. A method for cross-platform message exchange between a first device and a second device, wherein a first module in the first device is transmitted to the second device, comprising the steps of:
receiving a first message;
determining whether the first message is for the first module;
if the first message is for the first module, distributing the first message to the second device; and
transforming the first message into a format compatible with the second device.

2. The method of claim 1, wherein the second device has an application program, the method further comprising:
executing the application program along with the first module to obtain a second message;
determining whether the second message is for a second module in the first device;
if the second message is for the second module, transforming the second message into a format compatible with the first device; and
distributing the transformed second message to the second module in the first device.

3. The method of claim 2, wherein the application program is a test program for testing the first module.

4. The method of claim 2, wherein the application program is a debug program for debugging the first module.

5. The method of claim 1, wherein the first and second messages are transmitted via TCP/IP, 802.11×, RS232 or Bluetooth connection.

6. The method of claim 5, wherein the format is imported from a message database.

7. The method of claim 1, wherein the message is a communication protocol message.

8. The method of claim 1, wherein the first device is a mobile phone, a PDA (digital personal assistant), a MP3 player, a portable disk drive or a programmable consumer electronic.

9. A machine-readable storage medium storing a computer program which, when executed, performs a method for cross-platform message exchange between a first device and a second device, wherein at least one first module in the first device is transmitted to the second device, the method comprising:
receiving a message;
determining whether the message is for the first module;
if the message is for the first module, distributing the message to the second device; and
transforming the message into a format compatible with the second device.

10. A system for cross-platform message exchange between a first device and a second device, wherein at least one first module in the first device is transmitted to the second device, comprising:
a message distributor, disposed at the first device, for receiving a first message and determining whether the first message is for the first module, if the first message is for the first module, the message distributor distributes the first message to the second device; and
a converter, for transforming the first message into a format compatible with the second device.

11. The system of claim 10 further comprising an executor, for executing the application program along with the first module to obtain a second message, wherein the message distributor further determines whether the second message is for a second module in the first device, transforms the second message into a format compatible with the first device if the second message is for the second module, and distributes the transformed second message to the second module in the first device.

12. The system of claim 11, wherein the application program is a test program for testing the first module.

13. The system of claim 11, wherein the application program is a debug program for debugging the first module.

14. The system of claim 10, wherein the first and second messages are transmitted via TCP/IP, 802.11x, RS232 or Bluetooth connection.

15. The system of claim 10, wherein the format is imported from a message database.

16. The system of claim 10, wherein the first message is communication protocol message.

17. The system of claim 10, wherein the first device is a mobile phone, a PDA (digital personal assistant), a MP3 player, a portable disk drive or a programmable consumer electronic.

18. A method for cross-platform message exchange between a first device and a second device, wherein a first module in the first device is transmitted to the second device, comprising the steps of:
receiving a first message;
determining whether the first message is for the first module; and
if the first message is for the first module, distributing the first message to the second device,
wherein the second device transforms the first message into a format compatible with the second device.

19. A system for cross-platform message exchange between a first device and a second device, wherein at least one first module in the first device is transmitted to the second device, comprising:
a receiver for receiving a first message; and
a controller, coupled to the receiver, for determining whether the first message is for the first module, wherein if the first message is for the first module, the controller distributes the first message to the second device,
wherein the second device further transforms the first message into a format compatible with the second device.
